(19) United States
(12) Patent Application Publication
(10) Pub. No.: US 2008/0082209 A1
(43) Pub. Date: Apr. 3, 2008

(54) ROBOT ACTUATOR AND ROBOT ACTUATING METHOD

(76) Inventors: Sang Seung KANG, Daejeon (KR); Jae Hong KIM, Daejeon (KR); Joo Chan SOHN, Daejeon (KR); Young Jo CHO, Sungnam (KR)

Correspondence Address: LADAS & PARRY LLP, 224 SOUTH MICHIGAN AVENUE, SUITE 1600, CHICAGO, IL, 60604, US

(21) Appl. No.: 11/861,411

(22) Filed: Sep. 26, 2007

(30) Foreign Application Priority Data
Sep. 29, 2006 (KR) 10-2006-0096427

(51) Int. Cl. B25J 13/08

(52) U.S. Cl. 700/253; 901/46

(57) ABSTRACT

A robot actuator and a robot actuating method. In the robot actuator, when an input part detects an external stimulus signal according to a user's contact, a control part receives the detected external stimulus signal to create sensor data. The control part determines an output reaction, and an output actuator through the created sensor data and controls the output actuator according to the determined output reaction. Thus, an axial skeletal unit of an output part is moved according to an operation of the output actuator to express the output reaction. Accordingly, a natural, lively reaction of the robot actuator to an external stimulus can be achieved.

### CLAIM OF PRIORITY

This application claims the benefit of Korean Patent Application No. 10-2006-0096427 filed on Sep. 29, 2006 in the Korean Intellectual Property Office, the disclosure of which is incorporated herein by reference.

### BACKGROUND OF THE INVENTION

1. Field of the Invention

The present invention relates to a robot actuator and a robot actuating method, more particularly, to a robot actuator and a robot actuating method for expressing a natural, lively reaction to an external stimulus.

This work was supported by the IT R&D program of MIC/IITA [2006-S-026-01, Development of the URC Server Framework for Proactive Robotic Services]

2. Description of the Related Art

Recently, researches have been actively conducted on controlling operations of an emotion-model based robot in response to a user's command, an environment, and sensor information. For example, a pet robot system has been developed and improved, which gives a user a feeling of familiarity thereto. Such a robot system employs a technical method of creating an emotion or selecting a behavior using various sensors such as image, voice and tactile sensors mounted inside and outside a robot.

Also, to achieve natural human-robot interactions, there have been attempts to improve functions of a sensor device providing information related to an environment and generating an input value for a reaction to the information, and to provide lifelike effects to the robot.

Various researches are ongoing on a robot actuator, such as a polymer actuator, an actuator using a shape memory alloy, an artificial muscle actuator flexibly expanded and contracted to implement expansion and contraction of a human muscle.

However, in many cases, such researches remain at an initial stage because of problems related to durability, low outputs, and low operation rates. Also, in the case of a pneumatic artificial muscle actuator system, since a separate device for compressed air is essential, it is difficult to apply the actuator system to a small robot such as a pet robot.

Thus, although a natural movement of a robot has been improved through development of motor technologies, it is still needed to develop a more flexible actuator in order to achieve more natural, lively movements of the robot.

### SUMMARY OF THE INVENTION

The present invention has been made to solve the foregoing problems of the prior art and therefore an aspect of the present invention is to provide a robot actuator and a robot actuating method for achieving a lively reaction of a robot system to an external stimulus.

Another aspect of the invention is to provide a flexible robot actuator and a robot actuating method capable of expressing more natural, lively movements by constructing a motor, a fluid, and an axial skeletal unit in an output part and performing complex control on those elements.

According to an aspect of the invention, a robot actuator includes: an input part detecting an external stimulus signal according to a user's contact; a control part receiving the detected external stimulus signal, creating a sensor data by using the received external stimulus signal, determining an output part including the output actuator and one or more axial skeletal units moved by driving of the output actuator, expressing the output reaction according to a movement of the axial skeletal unit, and having viscosity, the viscosity being changed by applying a voltage to electrodes formed at one region of the axial skeletal unit and a body to induce a movement of the axial skeletal unit.

According to another aspect of the invention, A robot actuating method includes the steps of: detecting an external stimulus signal according to a user's contact; creating sensor data from the detected external stimulus signal; determining an output reaction and an output actuator on the basis of the created sensor data; controlling the output actuator according to the determined output reaction; and moving one or more axial skeletal units forming a skeletal structure of a movement according to driving of the output actuator to express the output reaction; wherein the robot actuator induce the movement of the axial skeletal unit through a viscosity change by actuating the fluid according to the output reaction, when the determined output part is a fluid.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating of a robot actuator reacting to an external stimulus according to an embodiment of the present invention;

FIG. 2 is a block diagram of a detailed structure of an output part of a robot actuator according to an embodiment of the present invention;

FIGS. 3A and 3B are views illustrating movements of an axial skeletal unit according to a determined output reaction according to an embodiment of the present invention;

FIG. 4 is a block diagram illustrating reaction output of an output part (back portion) with respect to an external stimulus according to an embodiment of the present invention; and

FIG. 5 is a flowchart of a process for controlling reaction output of an output part (back portion) with respect to an external stimulus according to an embodiment of the present invention.

### DETAILED DESCRIPTION OF THE PREFERRED EMBODIMENT

Exemplary embodiments of the present invention will now be described in detail with reference to the accompanying drawings. Like reference numerals refer to like elements throughout. Accordingly, in some embodiments, well-known processes, well-known device structures, and well-known techniques will not be described in detail to avoid ambiguous interpretation of the present invention.

In a robot system according to an embodiment of the present invention, a flexible robot actuator responsive to an external stimulus, and a robot actuating method will be described. First, the robot actuator will now be described in detail with reference to accompanying drawings.

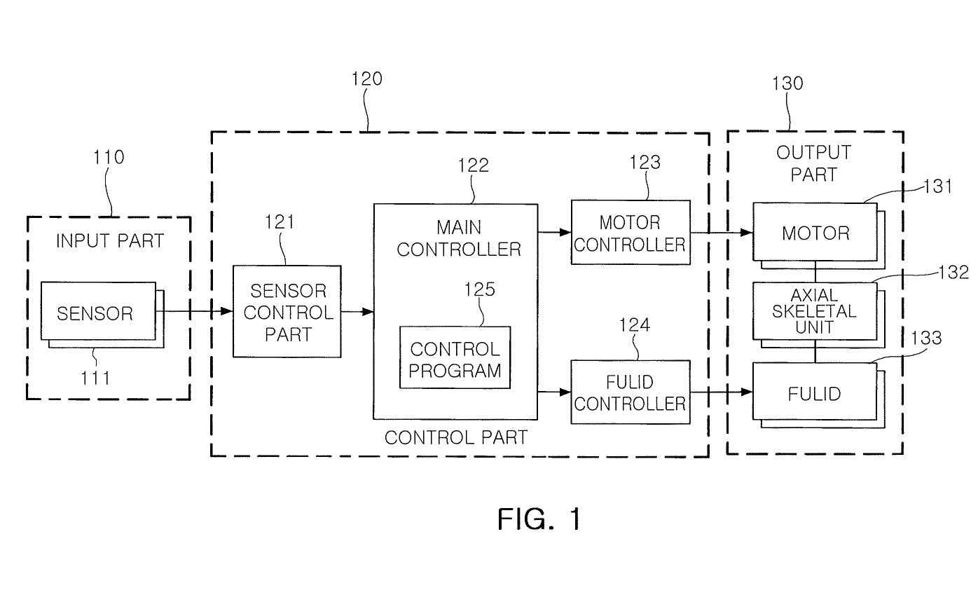

FIG. 1 is a block diagram of a robot actuator responsive to an external stimulus according to an embodiment of the present invention.

Referring to FIG. 1, the robot actuator includes an input part 110 receiving an external stimulus, a control part 120 performing control so that a reaction is made in response to an input external stimulus signal, and an output part 130 expressing the reaction in response to the input external stimulus signal.

The input part 110 includes a detection device such as a plurality of sensors 111 receiving an external stimulus. The detection device is disposed at a specific region of a body (e.g., at a head part of a robot), or an entire region of the body. Various sensors such as tactile, image and voice sensors, or other units for detecting a user's touch may be used as the detection device.

The control part 120 includes a sensor controller 121, a main controller 122 including a control program 125, a motor controller 123, and a fluid controller 124.

The sensor controller 121 detects a sensor value with respect to an external stimulus signal input to the input part 110, converts the input external stimulus signal into a digital signal, creates sensor data by using the converted input signal and transfers the created sensor data to the main controller 122.

The main controller 122 determines an output reaction, an output part, and an output actuator. The main controller 122 has an embedded operating system, and has a main control board configuration including a central processing unit, a memory for storing a program and data, and a communication interface. The control program 125 is executed at the memory, determines an output reaction on the basis of input data and state data, and selects an output part 130 and an output actuator. Also, the control program 125 may be configured to receive behavior information determined based on a created emotion by interworking with an emotion engine, and allow an reaction expression including the emotion, in the case where it is determined that an emotion is required.

The motor controller 123 controls a motor of the output part 130 according to the output reaction determined at the main controller 122, and controls a movement of an axial skeletal unit by actuating the motor.

The fluid controller 124 controls a smart fluid undergoing a viscosity change according to the output reaction determined at the main controller 122, and controls a movement of the axial skeletal unit of the output part 130 by changing the viscosity of the fluid. Here, the fluid controller 124, the motor controller 123, and the sensor controller 121 are configured as auxiliary controllers having communication interfaces with a microprocessor or a micro-controller, and perform a control function and a signal processing function through communication with the main controller 122.

The output part 130 includes a motor 131 actuated by control of the motor controller 123, a fluid 133 actuated by control of the fluid controller 124, and an axial skeletal unit 132 moved by actuation of the motor 131 and the fluid 133. The output part 130 flexibly expresses a reaction to an external stimulus through the axial skeletal unit 132 serving as a skeletal structure of a movement. A detailed structure of the output part 130 for expressing to a reaction to an external stimulus will now be described.

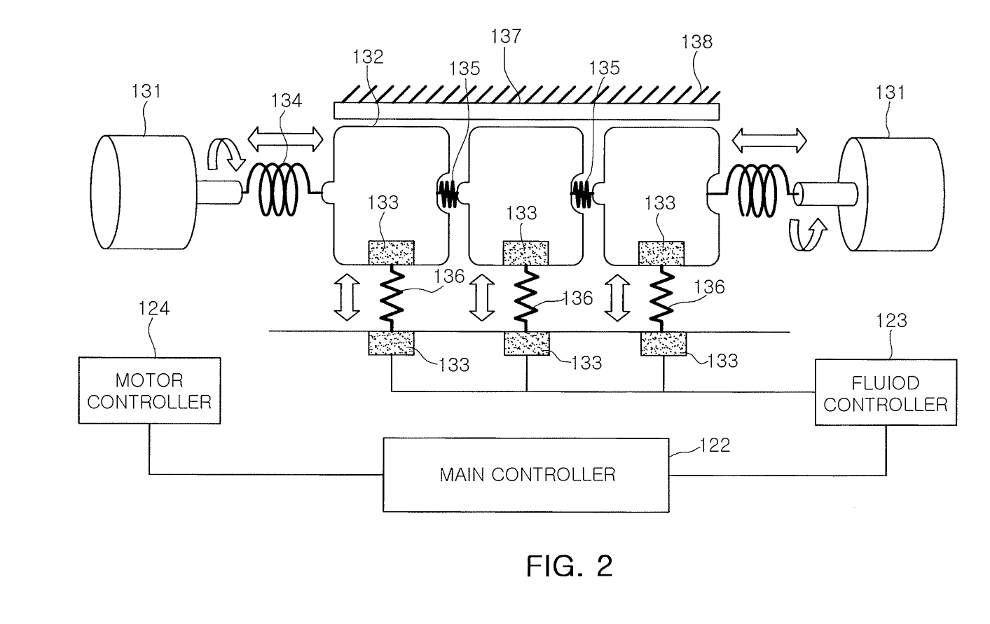

FIG. 2 is a block diagram illustrating a detailed structure of an output part of a robot actuator according to an embodiment of the present invention.

Referring to FIG. 2, in the output part 130, gear wire mechanisms 134 are formed at both sides of one or more axial skeletal units 132 constructing a skeletal structure of a movement, and connect the axial skeletal units 132 with motors 131. The one or more axial skeletal units 132 are connected through elastic mechanisms 135 so as to propagate contraction and expansion of one axial skeletal unit to another axial skeletal unit. A fluid 133 region formed at each axial skeletal unit 132 is connected with a fluid 133 region controlled by a fluid controller 124 through a fluid wire mechanism 136, so that the axial skeletal unit 132 is moved by a fluid viscosity change. The gear wire mechanism 134 converts a rotary motion of the motor 131 to a linear contraction motion to induce a movement of the axial skeletal unit 132. The fluid wire mechanism 136 includes an electrode and a coil spring connected to induce a movement of the axial skeletal unit 132 by the viscosity change of the fluid. The fluid 133 exists at each axial skeletal unit 132, and is operated inside the axial skeletal unit 132 or at one of connected body parts.

Also, the output part 130 may include an embedded sensor (not shown) that detects contact of a user, and an outer cover 137 surrounding the axial skeletal unit 132 for protection. A surface of the outer cover 137 is formed of a flexible, soft material rather than a hard material such as aluminum. The outer cover 138 formed of a material that is soft and pleasant to touch can make human feel friendlier toward a corresponding robot.

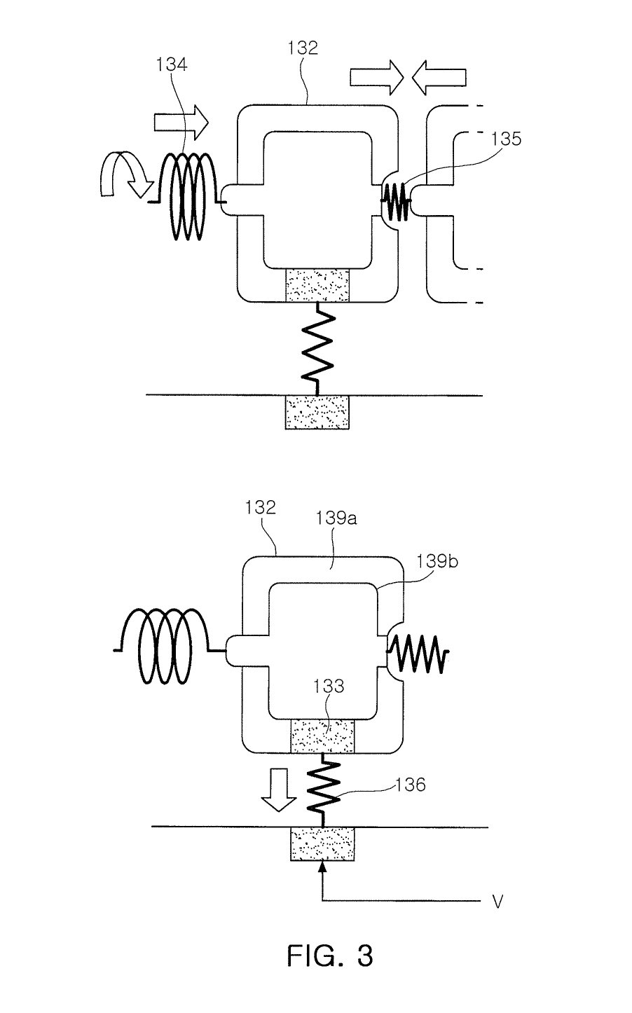

A movement state of the axial skeletal unit 132 of the output part 130 according to an output reaction determined at the main controller 122 in the above structure of the output part 130 will now be described with reference to accompanying drawings. A movement state by motor actuation will be described first with reference to FIG. 3A, and then, a movement state by a fluid viscosity change will be described with reference to FIG. 3B.

As illustrated in FIG. 3A, when receiving a tensile force through the gear wire mechanism 134, a first axial skeletal unit 132 of the output part 130 is moved in a direction that the force is applied. Then, a force is transmitted to a second axial skeletal unit connected to the first axial skeletal unit 132, and thus the second axial skeletal unit is moved according to a magnitude of the transmitted force. The elastic mechanism 135 connected between the first and second axial skeletal units serves to provide a flexible connection and transmit the force therebetween.

Referring to FIG. 3B, when a voltage is applied to the fluid controller 124, the viscosity of a fluid 123 is changed. The viscosity change causes both electrodes of the fluid wire mechanism 136 to be compressed. Thus, the fluid wire mechanism 136 is contracted, pulling the axial skeletal unit 132 inwardly of the body. An outer portion 139a of the axial skeletal unit 132 is formed of a flexible material such as silicon rubber, and an inner portion 139b of the axial skeletal unit 132 is formed of a light, strong material such as engineering plastic, so that more natural movements can be created.

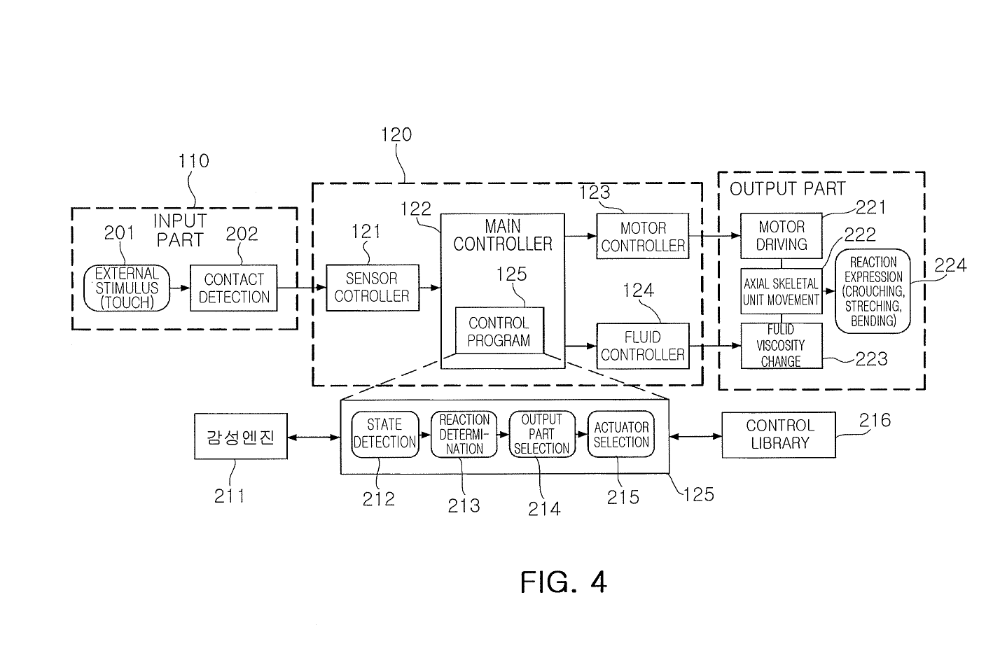

In the robot actuator having the above structure according to an embodiment of the present invention, when an external stimulus by a user's touch is input to a head portion, the input part 110, output occurs at a back portion, the output part 130. Detailed functions of each of the elements for the above operation will now be described with reference to FIG. 4.

Referring to FIG. 4, when an external stimulus 201 is input to the input part 110, sensors 111 perform contact detection 202, and send an external stimulus signal to the sensor controller 121. Then, the sensor controller 121 of the control part 120 performs state detection 212, output reaction determination 213, output part selection 214, and output actuator selection 215 at the control program 125 in execution, and then transmits control data to the motor controller 123 and the fluid controller 124. The control program 125 performs controls, interworking with an emotion engine 211 and a control library 216 so that an emotion-based behavior is expressed.

Motor actuation 211 and fluid viscosity change 223 is performed at the back portion, the output part 130, under control of the control part 120, and thus a movement 222 of the axial skeletal unit 132 is induced. Then, the output part 130 performs a reaction expression 224 according to the movement 222 of the axial skeletal unit 132. For example, the output part 130 can express various reactions such as crouching, stretching, and bending according to the movement 222 of the axial skeletal unit 132.

A robot actuating method capable of expressing a reaction to an external stimulus in the robot actuator having the above structures and functions will now be described in detail.

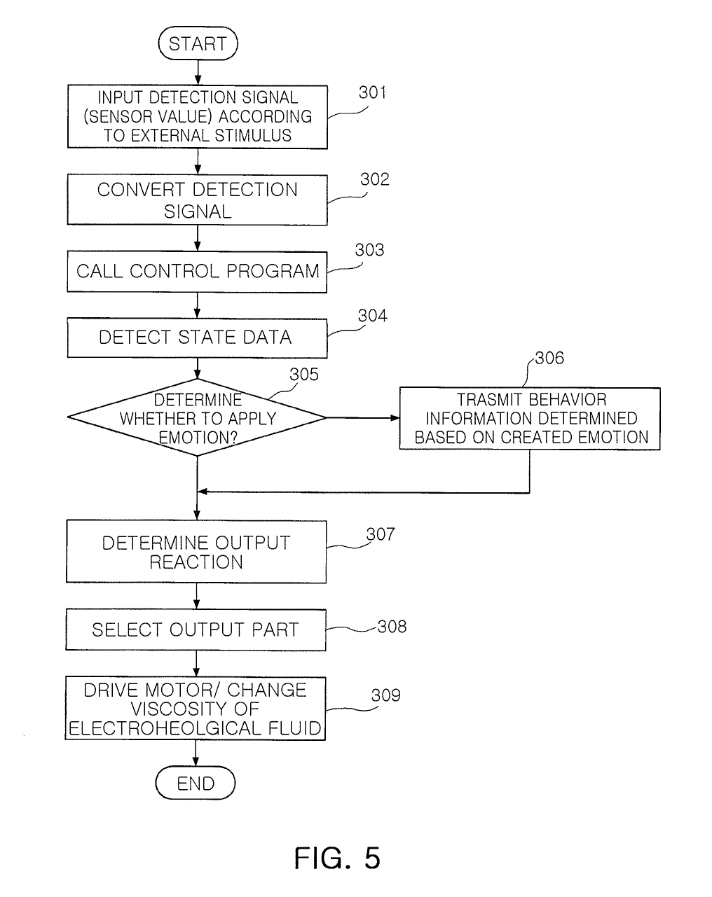

FIG. 5 is a flowchart illustrating a process of controlling a reaction output at the output part (back portion) according to an embodiment of the present invention.

Referring to FIG. 5, when a user gives an external stimulus through contact, the input part 110 of the robot actuator senses the contact using the sensors, detects a sensor value, and transmits the sensor value to the sensor controller 121.

In step S301, the control part 120 receives a detection signal (i.e., the sensor value) with respect to the external stimulus from the input part 110. Thereafter, in step 302, the control part 120 converts the analog input detection signal into a digital signal, and inputs sensor data, the converted signal, to the main controller 122. In step 303, the control part 120 calls the control program 125 being executed at the memory of the main controller 122. In step 304, the control part 120 detects state data from a state storage.

In step 305, the control part 120 determines through the main controller 122 whether to express an emotion-based behavior through the emotion engine 211 on the basis of the sensor data and the state data, that is, whether to apply an emotion. In the case of absence of predefined output reactions, and consecutive sensor data input, an output reaction may be determined through the emotion engine 211.

In step 306, when the main controller 122 determines the application of an emotion in step 305, the control part 120 transmits the sensor data and the state data to the emotion engine 211 and performs control so that the emotion engine 211 determines behavior information based on the created emotion. Thus, the control part 120 receives the behavior information from the emotion engine 211, and then step 307 is performed.

In contrast, when it is determined in step 305 not to apply an emotion, the control part 120 determines an output reaction through a control program in step 307, and then selects an output part 130 and an output actuator according to the output reaction in step 308.

Thereafter, in step 309, the control part 120 transmits control data to the motor controller 123 or the fluid controller 124, that is, to the output actuator, according to the determined output reaction, and thus controls the motor or the fluid of the output part 130, thereby actuating the motor or changing viscosity of an electro-rheological fluid. In this manner, a reaction such as crouching, stretching and bending can be expressed. The motor controller 123 and the fluid controller 124 may perform operations at the same time, or just one of those may perform operations.

Through the control determination of the control part 120, the motor 131 of the output part 130 receives control data from the motor controller 123, and is actuated through a motor driver. As the axial skeletal unit 132 is linearly contracted or expanded right and left at a rotary angle of the motor, an operation and a reaction are expressed. Also, the axial skeletal unit 132 receives control data from the fluid controller 124 to change the viscosity of the electro-rheological fluid through voltage control. The viscosity change vertically contracts or expands the axial skeletal unit 132, so that an operation, a reaction, is expressed. After the above processes are performed, the output part 130 transmits result data indicating, for example, success or failure in a reaction expression to the control part 120.

As mentioned above, in the flexible robot actuator responsive to an external stimulus according to the present invention, the axial skeletal unit is moved upon selecting a motor or a fluid according to an output reaction determined from external-stimulus detection of the input part through the control program, so that more lively reactions can be obtained.

Also, the robot actuator is able to express an immediate reaction to favorable contact from a user such as hugging, or hostile contact such as hitting, and also able to express various reactions through emotion state changes using the emotion engine, so that a user may have a feeling that a robot employing the robot actuator is actually alive and moves. Accordingly, the robot actuator may be applied to a pet robot based on an emotion, so that the user may feel friendly toward the pet robot, and helps an emotional interaction.

As set forth above, according to exemplary embodiments of the invention, a motor, a fluid and an axial skeletal unit are implemented at an output part of the robot actuator. The fluid and the motor are controlled in response to an external stimulus detected by an input part, so that the axial skeletal unit can express natural and lively reactions, and a human may feel friendly toward a robot because of natural behavior expressions thereof.

While the present invention has been shown and described in connection with the preferred embodiments, it will be apparent to those skilled in the art that modifications and variations can be made without departing from the spirit and scope of the invention as defined by the appended claims.

What is claimed is:

1. A robot actuator comprising:
an input part detecting an external stimulus signal according to a user's contact;
a control part receiving the detected external stimulus signal, creating a sensor data by using the received external stimulus signal, determining an output reaction and an output actuator through the created sensor data, and controlling the output actuator according to the determined output reaction; and
an output part including the output actuator and one or more axial skeletal units moved by driving of the output actuator, expressing the output reaction according to a movement of the axial skeletal unit, and having viscosity, the viscosity being changed by applying a voltage to electrodes formed at one region of the axial skeletal unit and a body to induce a movement of the axial skeletal unit.

2. The robot actuator according to claim 1, wherein the output part comprises:
a motor actuated by the controller according to the output reaction, and inducing a movement of the axial skeletal unit to express the output reaction at a specific partition region; and
a gear wire mechanism connected between the motor and the axial skeletal unit and linearly contracted by rotation of the motor.

3. The robot actuator according to claim 1, wherein the output part comprises:
a fluid actuated by the control part according to the output reaction, changing the viscosity by applying the voltage; and
a fluid wire mechanism connected to both electrodes of the fluid and contracted by the viscosity change.

4. The robot actuator according to claim 2 or 3, further comprising, if a plurality of axial skeletal units are formed, an elastic mechanism connecting the axial skeletal units to propagate contraction and expansion of one of the axial skeletal units to another axial skeletal unit.

5. The robot actuator according to claim 1, wherein the control part comprises:
a sensor controller converting the detected external stimulus signal into a digital signal, creating and controlling sensor data by using the converted digital signal;
a main controller detecting state data according to input sensor data, and determining the output reaction and the output actuator from the input data and the state data;
a motor controller serving as the output actuator, and actuating a motor according to the output reaction, the motor inducing a movement of the axial skeletal unit to express the output reaction at a specific region; and
a fluid controller serving as the output actuator, and actuating a fluid according to the output reaction, the fluid inducing a movement of the axial skeletal unit through a viscosity change of the fluid.

6. The robot actuator according to claim 5, wherein the main controller includes a communication interface and a memory, and performs state-data detection, output-reaction determination, and output actuator determination through a control program executed at the memory.

7. The robot actuator according to claim 6, wherein the main controller performs control so that when it is determined through the control program that an emotion is required, creating behavior information on the basis of a created emotion by interworking with an emotion engine, and transmitting the created behavior information to express a reaction including an emotion to the output part.

8. A robot actuating method in a robot actuator comprising the steps of:
detecting an external stimulus signal according to a user's contact;
creating sensor data from the detected external stimulus signal;
determining an output reaction and an output actuator on the basis of the created sensor data;
controlling the output actuator according to the determined output reaction; and
moving one or more axial skeletal units forming a skeletal structure of a movement according to driving of the output actuator to express the output reaction; wherein the robot actuator induce the movement of the axial skeletal unit through a viscosity change by actuating the fluid according to the output reaction, when the determined output part is a fluid.

9. The method according to claim 8, wherein the step of controlling the output actuator comprises the steps of:
converting the detected external stimulus signal into a digital signal;
creating sensor data by using the converted digital signal;
detecting state data by calling a preset control program according to the sensor data;
determining the output reaction and the output actuator from the input data and the state data through the control program;
driving the determined output actuator according to the determined output reaction to induce a movement of the axial skeletal unit; and
expressing the output reaction by the movement of axial skeletal unit.

10. The method according to claim 9, wherein in the step of driving the determined output actuator to induce the movement of the axial skeletal unit comprises the steps of:
actuating the motor according the output reaction, when the determined output part is a motor; and
inducing the movement of the axial skeletal unit to express the output reaction at a specific partition region of a robot body.

11. The method according to claim 9, further comprising the steps of:
creating behavior information on the basis of a created emotion by interworking with an emotion engine when it is determined that an emotion is required through the control program; and
expressing a reaction including the emotion by using the created behavior information.

12. The method according to claim 8, wherein the step of moving the axial skeletal unit to express the output reaction comprises the steps of:
transmitting a tensile force to the axial skeletal unit through a gear wire mechanism linearly contracted by rotation of a motor, when the output actuator is the motor; and
moving the axial skeletal unit in a direction that the tensile force is applied to express the output reaction.

13. The method according to claim 12, further comprising the step of transmitting a force through an elastic mechanism for a flexible connection between the axial skeletal units, when a plurality of axial skeletal units are formed.

14. The method according to claim 8, wherein the step of moving the axial skeletal unit to express the output reaction comprises:
contracting a fluid wire mechanism according to a viscosity change of a fluid when the output actuator is the fluid, the fluid wire mechanism connecting both electrodes of the fluid; and
pulling the axial skeletal unit inwardly of a body according to contraction of the fluid wire mechanism to express the output reaction.
